(19) United States
(12) Patent Application Publication
(10) Pub. No.: US 2012/0323923 A1
(43) Pub. Date: Dec. 20, 2012

(54) Sorting Data in Limited Memory

(75) Inventor: Junan Duan, Lewisville, TX (US)

(73) Assignee: Bank of America Corporation, Charlotte, NC (US)

(21) Appl. No.: 13/160,056

(22) Filed: Jun. 14, 2011

(51) Int. Cl. G06F 7/08; G06F 17/30

(52) U.S. Cl. 707/741; 707/E17.002

(57) ABSTRACT

A system for sorting tables comprises an interface operable to receive a first segment of an index column and a first segment of a key column from an on-disk database (ODDB), wherein a value in the index column represents a row of information in the ODDB and a value in the key column represents data to be sorted and each index value is associated with a key value, and wherein the ODDB is operable to store the sorted index values and key values in the first segments, a processor communicatively coupled to the interface, the processor is operable to sort the index values in the first segment and key values in the first segment by the key values according to sorting criteria, remove the sorted index values and key values in the first segments from an in-memory database in a sorting module, and the interface is operable to receive a second segment of the index column and a second segment of the key column from the ODDB.

### TECHNICAL FIELD

The present invention relates generally to data organization, and more specifically, to sorting data in limited memory.

### BACKGROUND

Enterprises often store data in large databases. At times, it may be desirable to sort the stored data for organizational purposes and to facilitate later retrieval.

### SUMMARY OF THE DISCLOSURE

In accordance with the present invention, disadvantages and problems associated with previous techniques for sorting tables in limited memory may be reduced or eliminated.

According to one embodiment of the present invention, a system for sorting tables comprises an interface operable to receive a first segment of an index column and a first segment of a key column from an on-disk database (ODDB), wherein a value in the index column represents a row of information in the ODDB and a value in the key column represents data to be sorted and each index value is associated with a key value, and wherein the ODDB is operable to store the sorted index values and key values in the first segments, a processor communicatively coupled to the interface, the processor is operable to sort the index values in the first segment and key values in the first segment by the key values according to sorting criteria, remove the sorted index values and key values in the first segments from an in-memory database in a sorting module, and the interface is operable to receive a second segment of the index column and a second segment of the key column from the ODDB.

According to another embodiment of the present invention, a non-transitory computer readable medium comprising logic for sorting tables, the logic, when executed by a processor, is operable to receive a first segment of an index column and a first segment of a key column from an on-disk database (ODDB), wherein a value in the index column represents a row of information in the ODDB and a value in the key column represents data to be sorted and each index value is associated with a key value, sort the index values in the first segment and key values in the first segment by the key values according to sorting criteria, store the sorted index values and key values in the first segments on the ODDB, remove the sorted index values and key values in the first segments from an in-memory database in a sorting module, and receive a second segment of the index column and a second segment of the key column from the ODDB.

According to yet another embodiment of the present invention, a method for sorting tables, comprises receiving, at a sorting module, a first segment of an index column and a first segment of a key column from an on-disk database (ODDB), wherein a value in the index column represents a row of information in the ODDB and a value in the key column represents data to be sorted and each index value is associated with a key value, sorting, using a processor in the sorting module, the index values in the first segment and key values in the first segment by the key values according to sorting criteria, storing the sorted index values and key values in the first segments on the ODDB, removing the sorted index values and key values in the first segments from an in-memory database in the sorting module, and receiving a second segment of the index column and a second segment of the key column from the ODDB.

Certain embodiments of the invention may provide one or more technical advantages. A technical advantage of an embodiment includes providing for large tables to be sorted in memory devices with storage capacities smaller than the data being sorted. Using a smaller memory device to sort the data improves the efficiency with which the data is sorted. Another technical advantage of an embodiment includes reducing the time required to sort large amounts of data. Yet another technical advantage of an embodiment includes reducing the computing resources necessary to sort large amounts of data.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 illustrates a block diagram illustrating a system for sorting data in limited memory;

FIG. 2A illustrates an embodiment of an on-disk database comprising a table of data;

FIG. 2B illustrates an embodiment of an in-memory database to sort data; and

FIG. 3 illustrates a flow chart of an embodiment of a method for sorting data in limited memory.

### DETAILED DESCRIPTION OF THE DRAWINGS

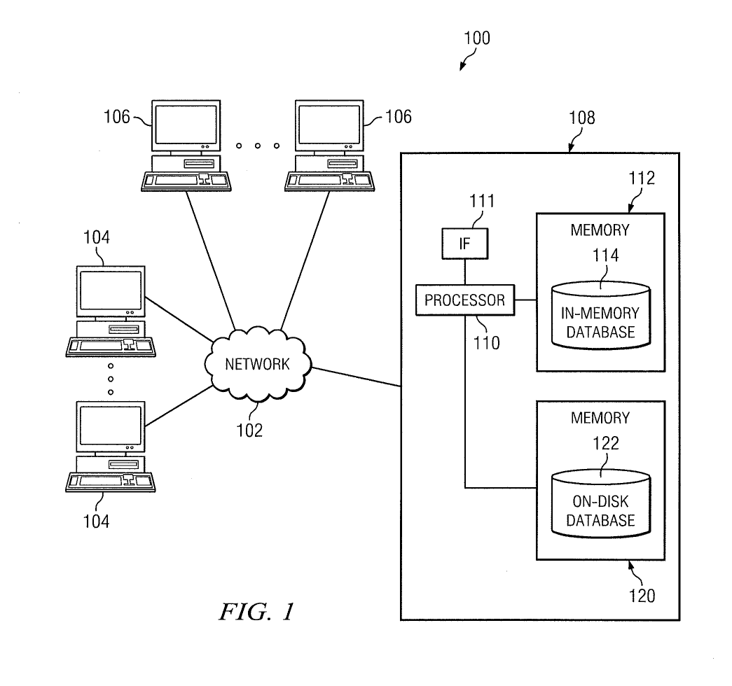

Embodiments of the present invention and its advantages are best understood by referring to FIGS. 1 through 3 of the drawings, like numerals being used for like and corresponding parts of the various drawings.

FIG. 1 illustrates a block diagram illustrating system 100 for sorting data in limited memory. System 100 includes network 102, one or more data sources 104, one or more clients 106, and sorting module 108. Sorting module 108 comprises processor 110, memory 112 that includes in-memory database 114, and memory 120 that includes on-disk database 122.

Enterprises often store large amounts of data in databases. Large databases are often stored in high-capacity' memory devices that have slower read or write times than other available memory devices. Sorting large amounts of data in these high-capacity memory devices may require large amounts of time and computing resources due to the slow read or write times. An enterprise may utilize a memory device with faster read or write times to sort data in less time and with fewer computing resources. However, faster memory devices often do not have the storage capacity to store the entire amount of data that needs to be sorted at one time. An enterprise may divide data to be sorted into sections small enough to load into a faster memory device and cycle the sections of data through the faster memory device for sorting.

Network 102 represents any suitable network operable to facilitate communication between the components of system 100 such as data sources 104, clients 106, and sorting module 108. Network 102 may include any interconnecting system capable of transmitting audio, video, signals, data, messages, or any combination of the preceding. Network 102 may include all or a portion of a public switched telephone network (PSTN), a public or private data network, a local area network (LAN), a metropolitan area network (MAN), a wide area network (WAN), a local, regional, or global communication or computer network, such as the Internet, a wireline or wireless network, an enterprise intranet, or any other suitable communication link, including combinations thereof, operable to facilitate communication between the components.

Data sources 104 represent any device capable of storing, retrieving and/or processing any suitable form of electronic data and supplying it to on-disk database 122 over network 102. In particular embodiments, data sources 104 represent a mainframe, a server, an electronic disk drive, a relational database management system, a personal computer, network attached storage, a storage area network, and/or any other electronic storage device to store data. In particular embodiments, a particular data source 104 may be different with respect to other data sources 104. For example, one data source 104 may represent a disk drive in a personal computer storing a flat file, one data source 104 may represent a relational database management system that stores tables of customer account information, and one data source 104 may represent a storage area network that stores transaction history. In particular embodiments, data source 104 may communicate trading information, such as stock prices, ticker symbols, transaction dates, transaction times, or other suitable financial information to on-disk database 122.

Clients 106 represent entities that communicate messages, such as database queries or other sorting criteria, to system 100. In particular embodiments, clients 106 represent general or special-purpose computers operating software applications capable of performing the above-described operations. For example, clients 106 may include, but are not limited to, laptop computers, desktop computers, portable data assistants (PDAs), and/or portable media players. In some embodiments, client 106 comprises a general-purpose personal computer (PC), a Macintosh, a workstation, a Unix-based computer, a server computer, or any suitable processing device. Additionally, in particular embodiments, client 106 may include one or more processors operable to execute computer logic and/or software encoded on non-transitory tangible media that performs the described functionality. Client 106 may also include one or more computer input devices, such as a keyboard, trackball, or a mouse, and/or one or more Graphical User Interfaces (GUIs), through which a user may interact with the logic executing on the processor of client 106. In general, client 106 includes any appropriate combination of hardware, software, and/or encoded logic suitable to perform the described functionality. Clients 106 may couple to network 100 through a dedicated wired or wireless connection, or may connect to network 100 only as needed to receive, transmit, or otherwise execute applications. Although FIG. 1 illustrates, for purposes of example, a particular number and type of clients 106, alternative embodiments of system 100 may include any appropriate number and type of clients 106, depending on the particular configuration of system 100.

In the illustrated embodiment, sorting module 108 represents any suitable component that facilitates the sorting of data in limited memory. In some embodiments, sorting module 108 may execute any suitable operating system such as IBM's zSeries/Operating System (z/OS), MS-DOS, PC-DOS, MAC-OS, WINDOWS, a .NET environment, UNIX, OpenVMS, or any other appropriate operating system, including future operating systems. The functions of sorting module 108 may be performed by any suitable combination of one or more servers or other components at one or more locations. In the embodiment where the module is a server, the server may be a private server, and the server may be a virtual or physical server. Also, sorting module 108 may include any suitable component that functions as a server.

In the illustrated embodiment, sorting module 108 comprises processor 110, interface 111, memory 112, which includes in-memory database 114, and memory 120, which includes on-disk database 122. Processor 110 may comprise one or more processors, and communicatively couples to interface 111, memory 112, in-memory database 114, memory 120, on-disk database 122, and network 102, and controls the operation and administration of sorting module 108 by processing information received from network 102, memory 112, in-memory database 114, memory 120, and on-disk database 122. Processor 110 includes any hardware and/or software that operates to control and process information. Processor 110 may be a programmable logic device, a microcontroller, a microprocessor, any suitable processing device, or any suitable combination of the preceding.

Interface 111 represents any suitable device operable to receive information from network 102, data sources 104, and/or clients 106, transmit information through network 102, perform processing of information, communicate to other devices, or any combination of the preceding. For example, interface 111 may receive messages relating to financial transactions from data sources 104 and/or clients 106. Interface 111 represents any port or connection, real or virtual, including any suitable hardware and/or software, including protocol conversion and data processing capabilities, to communicate through network 102 that allows sorting module 108 to exchange information with data sources 104, clients 106, or other components of system 100.

Memory 112 and 120 may store, either permanently or temporarily, data, operational software, or other information for processor 110. Memory 112 and 120 include any one or a combination of volatile or non-volatile local or remote devices suitable for storing information. For example, memory may include random access memory (RAM), read only memory (ROM), magnetic storage devices, optical storage devices, semiconductor storage devices, or any other suitable information storage device or a combination of these devices. Memory 112 and 120 may include any suitable information for use in the operation of sorting module 108. In a particular embodiment, memory 112 represents a memory device that may read, write, or store data faster than memory 120 and may have a smaller storage capacity than memory 120. For example, memory 112 may be less than a terabyte, and memory 120 may be multiple terabytes.

In-memory database 114 represents one or more databases in memory 112 operable to receive and sort data from on-disk database 122 in response to queries or predetermined sorting criteria. On-disk database 122 represents one or more databases operable to receive and store data from data sources 104 over network 102.

Sorting module 108 may receive data from data sources 104 and store the data in on-disk database 122. Sorting module 108 may also receive sorting criteria from clients 106, or other source, that identifies one or more columns in one or more tables of on-disk database 122 to sort and/or identifies the type of sort to perform. For example, sorting module 108 may sort a column of values from least to greatest, in alphabetical order, from earliest to latest, or in any other suitable order. Sorting criteria may be predetermined or may come from queries transmitted to sorting module 108 from clients 106.

Sorting module 108 may receive queries from clients 106 that describe the sorting criteria to be done in in-memory database 114 for one or more columns of a table. Sorting module 108 sorts the data in in-memory database 114 according to the sorting criteria and returns sorted tables to the querying client 106. In another embodiment, sorting module 108 may perform sorts according to predetermined sorting criteria. The predetermined criteria may be defined by clients 106 or any other suitable source a predetermined time before the initiation of a sort. For example, sorting module 108 may access predetermined sorting criteria that instructs sorting module 108 to separate the messages received by on-disk database 122 from data sources 104 into one or more tables and sort the one or more tables by one or more columns at the end of each day. Sorting by predetermined sorting criteria may decrease the time and computing resources necessary to query on-disk database 122.

In an exemplary embodiment of operation, sorting module 108 receives sorting criteria that identify columns to sort in a table in on-disk database 122. The identified columns to be sorted are referred to as key columns. Sorting module 108 may add an index column to the table, where the values in the index column correspond to the pre-sort order of the rows in the key column before any sort occurs. For example, the first value in the index column may be 1, which corresponds to the first value in the unsorted key column. Index values may map sorted key column values to their original rows in table 200.

Sorting module 108 may then determine the amount of space memory 112 has available for in-memory database 114, and may determine whether the combined size of the index and key columns is larger than the available space in memory 112. If the combined size of the index and key columns is larger than the available space in memory 112, sorting module 108 may divide the index and key columns into sections so that the smaller index column and key column sections load into in-memory database 114. In an embodiment, sorting module 108 divides the index and key columns into sections so that at least two sections of the index column and the key column load into in-memory database 114. These sections of index and key columns may be referred to herein as index/key sections.

Sorting module 108 loads one or more index/key sections into in-memory database 114 and sorts the sections by key column according to the sorting criteria. In an embodiment, sorting module 108 loads index/key sections into in-memory database 114 in a sequential order. After the one or more index/key sections have been sorted, sorting module 108 saves the one or more sorted sections to on-disk database 122. Sorting module 108 may save sorted sections to on-disk database 122 in a sequential order, for example, in first in first out (FIFO) order. In an embodiment, sorting module 108 maintains one or more index/key sections in in-memory database 114 for at least two consecutive sorts to provide continuity across the index/key column sections as they are sorted and to ensure that the key column is completely sorted. For example, sorting module 108 may sort three or more index/key sections in in-memory database 114, and save the sorted first and second sections to on-disk database 122 while maintaining the last section(s) in in-memory database 114 for another sort.

If sorting module 108 does not maintain at least one index/key column section in in-memory database 114 for at least two consecutive sorts and the number of rows in the key column is divisible by the number of rows in the section size, then the rows in each section may only be sorted against the other rows in the section instead of against the entire column. This may happen because sorting module 108 may continue to load the same rows in each section. Alternatively, if sorting module 108 maintains at least one index/key column section in in-memory database 114 for at least two consecutive sorts, then the rows of index/key column sections may move across sections and sorting module 108 may ensure complete and accurate sorting of the key column.

Sorting module 108 determines whether any rows of the index/key column sections changed position during a sort. When the entire key column cycles through in-memory database 114 and is sorted without rows changing position, then the key column is completely sorted. Sorting module 108 may use the index column values that correspond to the sorted key column to map values in other columns of the table to the sorted key column, which provides for the sorting of the other columns in the table. Sorting module 108 may also use the index column values that correspond to each key column value as a guide to locate corresponding column values without sorting the non-key columns.

Any suitable component of system 100 may include an interface, logic, memory, and/or other suitable element. An interface receives input, sends output, processes the input and/or output and/or performs other suitable operations. An interface may comprise hardware and/or software. Logic performs the operation of the component, for example, logic executes instructions to generate output from input. Logic may include hardware, software, and/or other logic. Logic may be encoded in one or more non-transitory, tangible media, such as a computer-readable medium or any other suitable tangible medium, and may perform operations when executed by a computer. Certain logic, such as a processor, may manage the operation of a component. Examples of a processor include one or more computers, one or more microprocessors, one or more applications, and/or other logic.

Modifications, additions, or omissions may be made to system 100. For example, in-memory databases 114 or on-disk database 122 may include any number of tables to organize the received data. Sorting module 108 may sort any data from any source, according to any sorting criteria, in response to any indicator, such as a query, a pre-set time, or a predetermined event.

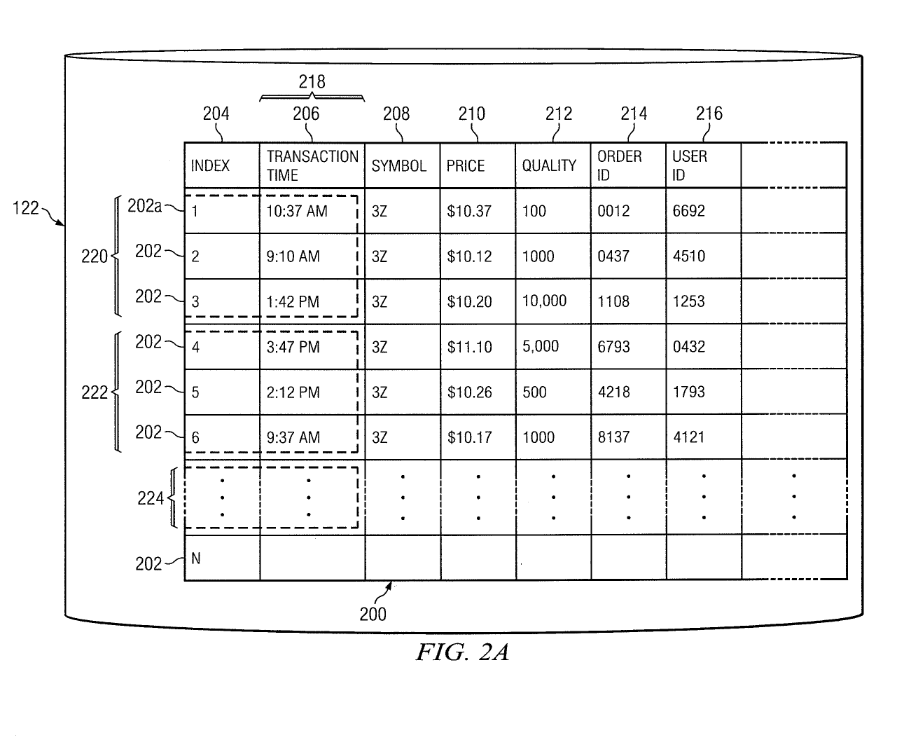

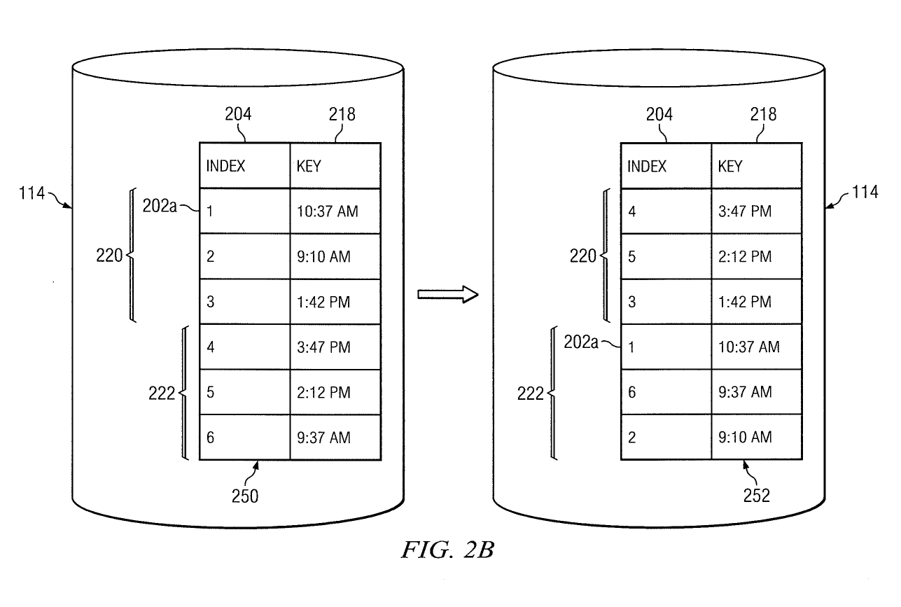

FIG. 2A illustrates an embodiment of on-disk database 122 comprising table 200. Table 200 includes a number of rows 202 and columns. In an embodiment, table 200 contains data relating to financial transactions, and columns may include transaction time column 206, symbol column 208, price column 210, quantity column 212, order ID column 214, and user ID column 216. Initially, table 200 may not include an index column 204 that indicates the row positions of the values in the columns. Sorting module 108 may add an index column 204 to table 200 to facilitate the sorting of columns.

In an embodiment, table 200 may comprise a number of column files, each storing a column of table 200. Rows 202 in each column file may be determined by a number of values or a number of memory positions. For example, each column value in a column may be allotted a kilobyte of memory, and the Nth row 202 of a column may be located by looking in the Nth kilobyte of memory. In another example, the Nth row 202 may be located by identifying the Nth value in a column.

Sorting criteria may identify one or more columns for sorting module 108 to sort. A column identified as a sorting column is referred to as a key column 218. In the illustrated embodiment, transaction time column 206 represents key column 218. Any column, and any number of columns, may be identified as key columns 218. Key columns 218 may be determined according to the sorting criteria included in a query or from predetermined sorting criteria. In an embodiment, sorting module 108 may concatenate the sorting of columns to sort multiple columns.

Each row 202 comprises a number of associated column values. For example, row 202 comprises a number of column values that relate to a particular transaction. In the illustrated embodiment, row 202a includes 10:37 AM in transaction time column 206, BAC in symbol column 208, $10.37 in price column 210, 100 in quantity column 212, 0012 in order ID column 214, and 6692 in user ID column 216. Each column may have a large number of rows 202 and each column value may require a large amount of memory, e.g., 1 kilobyte. Due to the large number of rows, and the large size of column values, the combined data in a single column may be very large, e.g., greater than 10 gigabytes. Column sizes of table 200 in on-disk database 122 may be larger than memory 112 has available for in-memory database 114.

As mentioned above, sorting criteria identifies transaction time column 206 as a key column 218 in the illustrated embodiment. Sorting module 108 may create an index column 204 for table 200 to maintain the association of values in rows 202 while key column 218 is sorted. In the embodiment, the combined size of index column 204 and key column 218 may be larger than the available space in in-memory database 114. Sorting module 108 may divide index column 204 and the key column 218 into sections small enough to load the various sections of index column 204 and key column 218 into in-memory database 114. The sections of index column 204 and key column 218 may be referred to as index/key column sections. In the illustrated embodiment, the index column 204 and key column 218 are divided into sections 220, 222, and 224. Each section includes three rows 202. In particular embodiments, the number of rows 202 in each section may be very large, e.g., 10,000 rows.

In an exemplary embodiment of operation, sorting module 108 receives data from data sources 104 and stores it on on-disk database 122. Sorting module 108 may receive sorting criteria, from queries or by accessing predetermined sorting criteria, that identifies one or more columns in one or more tables to be sorted. The identified columns become key columns 218. Sorting module 108 creates index column 204, which identifies the order of the values in key column 218 before sorting, and sorting module 108 divides index column 204 and key column 218 into sections such that one or more sections of index/key columns may load into in-memory database 114 at one time.

Modifications, additions, or omissions may be made to on-disk database 122. For example, sections of index/key columns to load into in-memory database 114 may be any suitable size. The appropriate size may be determined according to the number of rows, the memory size, or any other criteria. On-disk database 122 may include any number of tables, columns, or rows. Columns in tables may be stored as individual column files. Rows may be determined by counting the number of values, memory locations, or any other offset in a column.

FIG. 2B illustrates an embodiment of in-memory database 114 to sort data. In particular, in-memory database 114 sorts a column from on-disk database 122. In-memory database 114 includes one or more tables that may receive one or more sections of index/key columns from on-disk database 122. In the illustrated embodiment, table 250 represents an unsorted table of sections of index/key columns in database 114, and table 252 represents table 250 after sorting has occurred. In the illustrated embodiment, unsorted table 250 includes sections 220 and 222 of index/key columns. In this example, each section of index/key columns comprises three rows. Section sizes of index/key columns may be the same, different, or dynamic. Section sizes may be determined by a particular number of rows, a particular memory size, or any other suitable criteria.

Sorting module 108 may sort unsorted table 250 in in-memory database 114 by any suitable sorting criteria. Sorting module 108 may receive sorting criteria from queries, such as from clients 106, or may access predetermined sorting criteria. Sorting module 108 performs sorts in response to a query or an occurrence, such as a particular time, event, signal, or any other suitable occurrence that initiates the sort. In an embodiment, sorting module 108 may perform sorts of data at a specific time, such as at the end of the day, according to predetermined sorting criteria. In the illustrated embodiment, key column 218 values are specific times, and the sorting criteria specifies that sections of index/key columns in in-memory database 114 be sorted from latest time to earliest time.

Table 252 represents the sorted version of table 250. Sorting module 108 changed the position of the rows based on the sorting criteria. Some rows moved from section 220 to section 222 and from section 222 to section 220. However, the association between the values in index column 204 and the values in key column 218 remains the same. For example, row 202a has a value of 1 in index column 204 and a value of 10:37 AM in key column 218. Row 202a is included in section 200 in table 250. In table 252, row 202a moves to section 222 after the sort. However, row 202a maintains a value of 1 in index column 204 and a value of 10:37 AM in key column 218.

In the illustrated embodiment, after sorting sections 220 and 222, sorting module 108 writes section 220 back to on-disk database 122, maintains section 222 in in-memory database 114 for another sort, and loads a next section 224 into in-memory database 114. Maintaining section 222 in in-memory database 114 for multiple consecutive sorts allows the earliest times from the section 220 that sorted into section 222 to be sorted against section 224, and ensures that sorting module 108 completely sorts key column 218 from on-disk database 122.

Sorting module 108 may determine whether rows of index/key columns changed position during a sort, and whether the entire key column 218 from on-disk database 122 has been loaded into in-memory database 114 and sorted without rows changing position. If the entire key column 218 from on-disk database 122 has been loaded into in-memory database 114 and sorted without rows changing position, then the key column 218 has been completely sorted.

Sorting module 108 may use the index values from the sorted index/key columns to map the sorted key column 218 values to the other corresponding column values in table 200. In an embodiment, the values in index column 204 are a guide, and system 100 may determine other corresponding column values for key column 218 values by using the value in index column 204 as an offset to measure the other columns. For example, a key column 218 value may have a corresponding index column 204 value of 5. System 100 may look to the 5th memory location, or the 5th value, or any other offset, of other columns to determine the corresponding column values to the key column 218 that comprise a row in table 200. In this embodiment, only key columns 218 need to be sorted and the other columns may remain in their original order.

In another embodiment, sorting module 108 may use the values in index column 204 of the index/key columns to sort the non-key columns of table 200. Sorting module 108 may arrange the non-key columns by loading a number of sorted index column 204 values from the sorted index/key columns, and loading the corresponding column values, in order, from the non-key columns. For example, if the final ordering of the sorted index/key columns had rows 6, 4, and 9 as the values in the first section, then sorting module may load the 6th, 4th, and 9th value from a non-key column and then save the sorted section of non-key column values back to on-disk database 122.

Modifications, additions, or omissions may be made to in-memory database 114. For example, sections of index/key columns may be any size that may load into in-memory database 114, and may be determined by number of rows, by memory size, or any other criteria. Sorting module 108 may save sorted sections of index/key columns back to on-disk database 122 in any suitable fashion. Sorting module 108 may sort key column 218 any number of times until no rows change position. Sorting module 108 may, or may not, maintain sections of index/key columns in in-memory database 114 for multiple consecutive sorts.

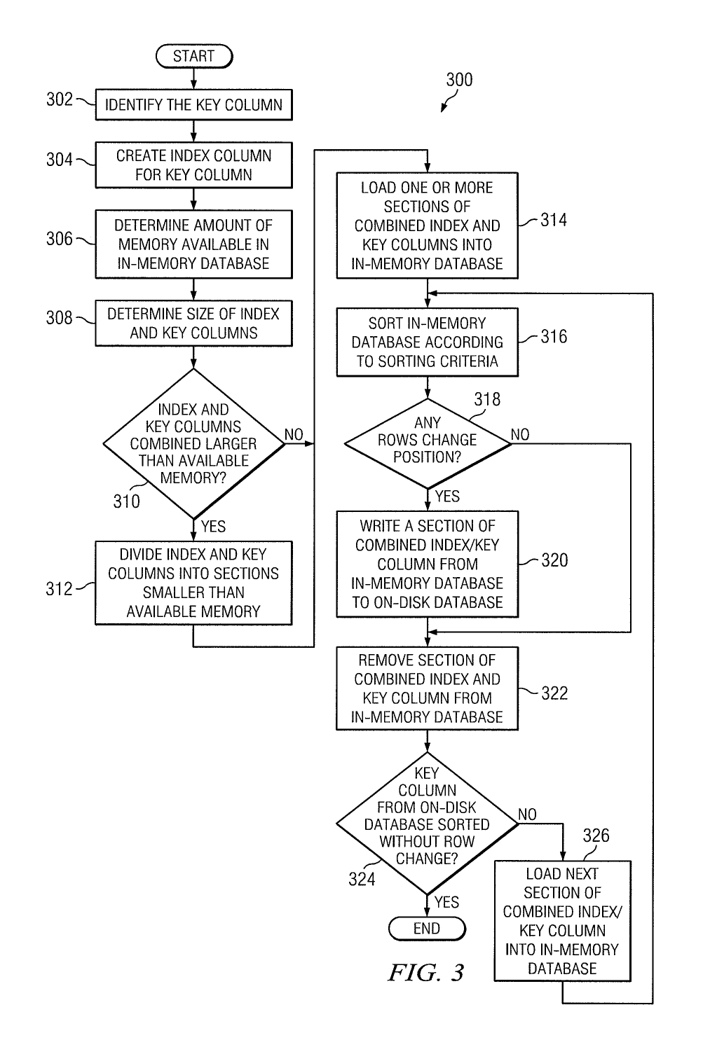

FIG. 3 illustrates a flow chart of an embodiment of a method 300 for sorting data in limited memory. Method 300 begins at step 302 where sorting module 108 identifies a column of a table in on-disk database 122 to sort. The column being sorted is referred to as the key column. Sorting module 108 may identify a key column based on sorting criteria.

At step 304, sorting module 108 creates an index column 204 that corresponds to key column 218. The index column 204 values may correspond to the order of the key column 218 values before the sort. For example, an index value of 5 may indicate that the key column 218 is the 5th value in the column, or the 5th memory location in a column, or any other suitable offset. Maintaining a row column 204 that corresponds to the pre-sort order of key column 218 allows sorting module 108 to preserve the associations of values within a row across multiple columns while only sorting a subset of the columns. An index column 204 value will correspond to the same key column 218 value before and after a sort.

At step 306, system 100 determines the amount of space available for database 114. The amount of space available in memory 112 for database 114 indicates the amount of data that sorting module 108 may sort in database 114 at one time. The amount of space available in memory 112 for database 114 may be dynamic or may be fixed. Sorting module 108 may ensure that a minimum amount of memory 112 may be available for database 114.

At step 308, sorting module 108 determines the combined size of the index column 204 and key column 218. At step 310, sorting module 108 determines whether the combined size of the index column and key column is larger than the available memory 112 in in-memory database 114. If the combined size of index column 204 and key column 218 is larger than the available memory for in-memory database 114, then method 300 continues from step 312. If the combined size of index column 204 and key column 218 is smaller than the available memory, then method 300 continues from step 314.

At step 312, sorting module 108 divides index column 204 and key column 218 into smaller sections. Each section of index/key column is small enough that one or more sections may be loaded into in-memory database 114. Sections may be a consistent number of rows or a consistent amount of data. The section size may be dynamic, and may depend on the size of the values in the key column 218. The size of the values in key column 218 may fluctuate, and a section with large values may comprise fewer rows than a section with smaller values. In an embodiment, a section comprises a number of rows of the index/key columns. At step 314, sorting module 108 loads one or more sections of the index/key columns into in-memory database 114. In an embodiment, in-memory database 114 may load at least two sections of the index/key columns.

At step 316, sorting module 108 sorts the one or more sections of index/key columns in in-memory database 114 according to key column 218. Sorting criteria may define how key column 218 is sorted, for example, from greatest to least, alphabetical order, earliest to latest, or any other suitable ordering. If multiple sections of index/key columns were loaded into in-memory database 114 before the sort, in-memory database 114 may move rows from one section to another section during the sort. Sorting the index/key columns according to key column 218 may change the order of the rows of the index/key columns, and which rows are in each section, but does not change the corresponding index/key values in each row. For example, if the value in key column 218 is in the same row as value 1 in index column 204 before a sort, the value of key column 218 will be in the same row as value 1 after a sort. The value of index column 204 may operate as a guide for the value of key column 218 so that the key column 218 value can be mapped to the other column values in the corresponding row of table 200 after key column 218 is sorted.

At step 318, sorting module 108 determines if any rows of the index/key columns changed position after the sort. If any rows changed position, method 300 continues from step 320. If no rows changed position, method 300 continues from step 322. At step 320, sorting module 108 writes a section of the index/key columns from in-memory database 114 to on-disk database 122. Sorting module 108 may write the section of the index/key columns to one or more column files in on-disk database 122. For example, the index/key columns may be saved to the original index and key column files or to new index and key column files.

At step 322, sorting module 108 removes one or more sections of index/key columns from the in-memory database 114. If rows moved during the previous sort, sorting module 108 removes the one or more sections of the index/key columns that sorting module 108 wrote to on-disk database 122. Sorting module 108 may maintain a number of sections of the index/key columns in in-memory database 114 for multiple sorts, for example for two consecutive sorts. As discussed above, maintaining a section of the index/key columns in in-memory database 114 for at least two consecutive sorts may ensure an accurate sort of the key column 218 by maintaining continuity between the discrete sections being sorted.

At step 324, sorting module 108 determines if every row of key column 218 from on-disk database 122 has been loaded into in-memory database 114 and sorted without rows changing position. If every row of the index/key columns from on-disk database 122 has not been loaded into in-memory database 114 and sorted without rows changing position, then the method continues from step 326. At step 326, sorting module 108 loads the next one or more sections of index/key columns into in-memory database 114. In an embodiment, the next section of index/key columns may be loaded into in-memory database 122 to be sorted with a remaining section of index/key columns from the previous sort.

If every row of key column 218 from on-disk database 122 has been loaded into in-memory database 114 and sorted without rows changing position, then key column 218 has been completely sorted and the method ends.

Modifications, additions, or omissions may be made to method 300. For example, sorting criteria may identify any column as key column 218. Sorting criteria may identify multiple key columns 218, and the method may repeat for each key column 218. Additionally, sorted rows from in-memory database 114 may be saved to on-disk database 122 in any suitable fashion. The method may include more, fewer, or other steps. Additionally, steps may be performed in any suitable order.

Although the present invention has been described in several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

What is claimed is:

1. A system for sorting tables, comprising:
an interface operable to receive a first segment of an index column and a first segment of a key column from an on-disk database (ODDB), wherein a value in the index column represents a row of information in the ODDB and a value in the key column represents data to be sorted and each index value is associated with a key value, and wherein the ODDB is operable to store the sorted index values and key values in the first segments;
a processor communicatively coupled to the interface, the processor is operable to:
sort the index values in the first segment and key values in the first segment by the key values according to sorting criteria;
remove the sorted index values and key values in the first segments from an in-memory database in a sorting module; and
the interface is operable to receive a second segment of the index column and a second segment of the key column from the ODDB.

2. The system of claim 1, wherein a size of a segment of the index column and a size of a segment of the key column are determined according to a size of the in-memory database in the sorting module.

3. The system of claim 1, wherein the sorted index value identifies additional data associated with the key value.

4. The system of claim 1, wherein the key column is identified according to sorting criteria contained in a query received from a client.

5. The system of claim 1, wherein the key column is a selected one of a plurality of data columns in the ODDB.

6. The system of claim 1, wherein the processor is further operable to:
sort the index values in the second segment and key values in the second segment according to the sorting criteria;
store the sorted index values and key values in the second segments on the ODDB; and
remove the sorted index values and key values in the second segments from an in-memory database in the sorting module.

7. The system of claim 1, wherein the processor is further operable to determine each segment of the index column and the key column have been sorted.

8. A non-transitory computer readable medium comprising logic for sorting tables, the logic, when executed by a processor, operable to:
receive a first segment of an index column and a first segment of a key column from an on-disk database (ODDB), wherein a value in the index column represents a row of information in the ODDB and a value in the key column represents data to be sorted and each index value is associated with a key value;
sort the index values in the first segment and key values in the first segment by the key values according to sorting criteria;
store the sorted index values and key values in the first segments on the ODDB;
remove the sorted index values and key values in the first segments from an in-memory database in a sorting module; and
receive a second segment of the index column and a second segment of the key column from the ODDB.

9. The computer readable medium of claim 8, wherein a size of a segment of the index column and a size of a segment of the key column are determined according to a size of the in-memory database in the sorting module.

10. The computer readable medium of claim 8, wherein the sorted index value identifies additional data associated with the key value.

11. The computer readable medium of claim 8, wherein the key column is identified according to sorting criteria contained in a query received from a client.

12. The computer readable medium of claim 8, wherein the key column is a selected one of a plurality of data columns in the ODDB.

13. The computer readable medium of claim 8, wherein the logic is further operable to:
sort the index values in the second segment and key values in the second segment according to the sorting criteria;
store the sorted index values and key values in the second segments on the ODDB; and
remove the sorted index values and key values in the second segments from an in-memory database in the sorting module.

14. The computer readable medium of claim 8, wherein the logic is further operable to determine each segment of the index column and the key column have been sorted.

15. A method for sorting tables, comprising:
receiving, at a sorting module, a first segment of an index column and a first segment of a key column from an on-disk database (ODDS), wherein a value in the index column represents a row of information in the ODDB and a value in the key column represents data to be sorted and each index value is associated with a key value;
sorting, using a processor in the sorting module, the index values in the first segment and key values in the first segment by the key values according to sorting criteria;
storing the sorted index values and key values in the first segments on the ODDB;
removing the sorted index values and key values in the first segments from an in-memory database in the sorting module; and
receiving a second segment of the index column and a second segment of the key column from the ODDB.

16. The method of claim 15, wherein a size of a segment of the index column and a size of a segment of the key column are determined according to a size of the in-memory database in the sorting module.

17. The method of claim 15, wherein the sorted index value identifies additional data associated with the key value.

18. The method of claim 15, wherein the key column is identified according to sorting criteria contained in a query received from a client.

19. The method of claim 15, wherein the key column is a selected one of a plurality of data columns in the ODDB.

20. The method of claim 15, further comprising:
sorting, using the processor in the sorting module, the index values in the second segment and key values in the second segment according to the sorting criteria;
storing the sorted index values and key values in the second segments on the ODDB; and
removing the sorted index values and key values in the second segments from an in-memory database in the sorting module.

21. The method of claim 15, further comprising determining each segment of the index column and the key column have been sorted.
